(19) United States
(12) Patent Application Publication
(10) Pub. No.: US 2024/0401279 A1
(43) Pub. Date: Dec. 5, 2024

(54) SURFACE SIZING AGENT FOR PAPER AND/OR CARDBOARD

(71) Applicant: MONDI AG, Wien (AT)

(72) Inventor: Johannes LEITNER, Leonding (AT)

(73) Assignee: MONDI AG, Wien (AT)

(21) Appl. No.: 18/679,507

(22) Filed: May 31, 2024

(30) Foreign Application Priority Data
May 31, 2023 (AT) A 50426/2023

(51) Int. Cl. D21H 21/16; C09D 197/00; D21H 19/12; D21H 23/22; D21H 27/34

(52) U.S. Cl. CPC D21H 21/16; C09D 197/005; D21H 19/12; D21H 23/22; D21H 27/34

(57) ABSTRACT

Surface sizing agents for paper and/or cardboard contain lignin and lignin sulfonates and at least one further surface-finishing substance, wherein it contains 0.1 to 50% by weight, preferably 5 to 20% by weight of a lignosulfonate source, 0.1 to 50% by weight, preferably 5 to 25% by weight of lignin, in particular kraft lignin and at least one further surface-finishing substance selected from the group of hydroxylated polymers, such as starch, PVOH, natural or synthetic hydrophobic materials, such as tall oil, tall oil soap or refined products thereof or hydrophobic materials, such as synthetic or natural waxes, styrenes, butadiene, acrylates, alkyl ketene dimer and oils thereof, such as AnKD, alkenyl succinic acid anhydride and the remainder water as a solvent and/or suspending agent, as well as processes for the production and use of the surface sizing agent.

### BACKGROUND OF THE INVENTION

The present invention relates to a surface sizing agent for paper and/or cardboard containing lignin and lignosulfonates and at least one further surface-finishing substance, a process for producing a surface sizing agent for paper and/or cardboard containing lignin and lignosulfonates and at least one further surface-finishing substance and the use thereof.

Surface sizing agents such as lignin have long been used in the production of paper and/or cardboard and, on the one hand, are intended to slightly increase the strength of paper, but on the other hand, above all, to provide a significantly increased water-repellent effect and thereby make the production process of paper and/or cardboard overall more favourable. Another possibility for using lignin or lignosulfonates in the treatment of paper is to use them as surface hydrophobic agents, in which case the lignin or lignosulfonates are dissolved and-applied to the paper surface as a mixture together with glycerin. Since glycerin is known to be very strongly hygroscopic, a surface treatment with glycerin alone can never result in a paper that has a dry surface and which is why lignin or lignosulfonates are added to such a mixture.

Furthermore, it is described in WO 2015/054736 A1, for example, that the surface of paper can be activated with lignin, whereby such activation can usually only be carried out at high temperatures of up to 240° C., temperatures which are so high that they are not normally present in a paper machine, so that the semi-finished paper has to be transferred to another plant for efficient surface activation, which makes the process significantly more complex and costly.

Another possibility for achieving an improvement in the surface properties of paper and/or cardboard is to carry out, in addition to the application of a surface sizing by means of surface treatments such as calendering, blasting, coating and the like, wherein in particular in the case of coating a wide variety of materials can be applied to the surface of a paper, which can change the surface properties of the paper to such an extent that paper treated in this way is suitable for a large number of usage purposes. It is furthermore known that lignin alone is a material that influences the surface of the paper. Lignin, which is a naturally occurring polymer, has a different effect on the surface of the paper depending on its degree of cross-linking, its water content and its average molar mass.

Finally, it is known that lignin can penetrate better into the outer layers of the paper surface the lower its molecular weight or its average molar mass or its hydrodynamic radius. Furthermore, as is also known to a person skilled in the art, with an increase in the average molar mass of a polymer, its solubility usually also decreases and the higher the average molar mass of a polymer, usually the greater its viscosity in solution or suspension, which general guidelines also apply to lignin. According to the findings of Roberts at al., Controlled black liquor viscosity reduction through salting-in, AiCHe Journal 1996, Vol. 42, No. 8 pages 2319-2386, through oxidative processes with oxidizing agents such as oxygen, air or hydrogen peroxide as well as high temperature treatments of alkaline lignin at over 160° C. molecular chains, especially of hemicelluloses and to a certain extent also of lignin are depolymerized.

It is furthermore known that in the course of the separation of lignin from black liquor, for example, the molecular structure of the lignin is present in condensed form during precipitation with sulphuric acid. The U.S. Pat. No. 9,464,219 B2 describes the reactivation of kraft lignin to produce lignin-phenol-formaldehyde resins by dispersing 10-50% lignin in an aqueous dispersion with an alkali source, such as sodium hydroxide or potassium hydroxide at 30-70° C. and at 50° C. to 95° C. The alkalisation of lignin unfolds its condensed structure here and thereby exposes the charge groups of lignin in solution. By saponifying lignin, i.e. mixing alkalis with lignin at higher temperatures, lignin is completely dissolved. It is only recommended to add a catalyst, namely an acid such as sulphuric acid, to the reaction at temperatures above 100° C. The alkalisation of lignin with alkaline earth metals is also not new and is known to those skilled in the art as the “salting-in” effect (according to Roberts et al. 1996). U.S. Pat. No. 9,464,219 B2 describes an ash content, i.e., alkaline earth metal ions, which at over 20% is only slightly below the values present in black liquor, the starting material for kraft lignin. Such a large amount of alkaline earth metals, i.e., salting-in, naturally leads to an opening of the specific surface of the lignin cluster, as described in U.S. Pat. No. 9,464,219 B2. However, the strong increase in the surface area of the lignin cluster, i.e., too large a hydrodynamic radius of lignin, is detrimental to the-penetration of starch into the paper surface and is therefore undesirable.

S. Kopacic et al., “Technical Lignins and their Utilization in the Surface Sizing of Paperboard”, Industrial and Engineering Chemical Research 2018, pages 6284 ff have shown that water-soluble kraft lignin can be used as a surface sizing agent for paper and that such a sizing agent has a number of advantages over conventional sizing agents. Thus, it was shown that the viscosity of a suspension to be used as a sizing agent can be reduced by 40% if lignin is used alone as a sizing agent and by 25% if lignin is used together with starch, in which case the solids content remained unchanged in each case, the contact angle of the surface-treated paper during printing after being wetted with water was 90° to 100° and it could also be shown that when paper surfaces are treated with mixtures of starch and lignin, analogous mechanical paper properties could be achieved compared to paper that is only treated with starch. Only the hydrophobic properties of the paper surface, i.e., the Cobb value, increased slightly with the treatment described compared to the use of starch alone. However, overall when using lignin as a sizing agent or a combination of starch and lignin as a sizing agent, values substantially comparable to those when using starch alone could be achieved.

In order that such a surface treatment with neutral or slightly basic lignin originating from paper or pulp production is possible at all, it must however be converted into a water-soluble form, which was also achieved by S. Kopacic at al. For this purpose, strongly acidic kraft lignin was dissolved in NaOH and converted into its Na form, which still remains water-soluble during a subsequent reduction of the pH into the weakly basic range with sulfuric acid and which, after its precipitation, can be applied as a surface sizing agent. The disadvantage of this process is that the lowering of the pH with sulfuric acid, which is absolutely necessary to separate lignin, leads to a severe salting and thus the hydrophobic effect of lignin is reduced. In the practical use of such a lignin, it is therefore again necessary to add large amounts of hydrophobic, synthetic sizing agents.

As is known from the prior art, it is therefore favorable or preferred to provide basic lignin which is able to penetrate into the paper and pulp surface. However, since lignin is a natural polymer and polymer molecules usually cannot or can only penetrate very little into rather dense surfaces due to their size, it is an aim of the present invention to provide a surface sizing agent which is able to penetrate deep into the paper structure and with which it is possible to significantly improve the surface properties of paper compared to known lignin-containing sizing agents or sizing agents consisting of lignin.

### SUMMARY OF THE INVENTION

To solve this problem, the surface sizing agent for paper and/or cardboard according to the invention is substantially characterized in that it contains 0.1 to 50% by weight, preferably 5 to 20% by weight, of a lignosulfonate source, 0.1 to 50% by weight, preferably 5 to 25% by weight, of lignin, in particular kraft lignin and at least one further surface-finishing substance-selected from the group of hydroxylated polymers, such as starch, PVOH, natural or synthetic hydrophobic materials, such as tall oil, tall oil soap or refined products thereof or hydrophobic materials such as synthetic or natural waxes, styrenes, butadiene, acrylates, alkyl ketene dimer and oils thereof, such as AnKD, alkenyl succinic anhydride and the remainder water as a solvent and/or suspending agent. Since the surface sizing agent for paper and/or cardboard contains 0.1 to 50% by weight, preferably 5 to 20% by weight, of a lignosulfonate source, it is surprisingly possible to provide a surface sizing agent which, as a result of the lignosulfonate source, which occurs in the neutral or weakly basic state, already has the required basic pH in order to be used as a surface sizing agent and which at the same time however is only so weakly basic that the lignin additionally contained in the surface sizing agent is still soluble in the water contained in the lignosulfonate source. Red liquor from an NSSC process or other lignosulfonates can preferably be used as the lignosulfonate source, such as a lignosulfonate originating from the magnesium sulfite or magnefite process or spray-dried lignosulfonates. According to a further development of the invention, red liquor from the NSSC process is preferably used. Furthermore, due to the weakly basic overall pH of the surface sizing agent, it can be applied directly to a paper surface without the need for pH adjustment. It has surprisingly become apparent that the surface sizing agent according to the invention has a significantly higher proportion of dissolved lignin than would be the case, for example, with conventional processes for producing surface sizing agents, even if these have an identical or almost identical pH as the lignosulfonate source used in the surface sizing agent according to the invention. It follows from this that by using a lignosulfonate source, such as red liquor, it is surprisingly possible to bring significantly larger amounts of lignin into solution than, for example, using kraft lignin alone. In this way, it is possible to provide a surface sizing agent which, due to the good solubility of the lignin in the lignosulfonate source used, contains significantly higher proportions of dissolved components and thus can penetrate better and more deeply into the paper surface of a paper to be coated therewith and/or a cardboard to be coated therewith and consequently the dust development of paper during further processing of paper, for example, into paper sacks or corrugated cardboard, can be reduced by lignin particles that have penetrated more deeply into the paper. For this reason, not only a more strongly hydrophobic surface of the paper is provided, but in particular a deeper and therefore more durable and more complete and in particular more homogeneous sizing of a paper surface is achieved.

The amount of sizing agent applied to the paper or board is in the usual range, namely between 1 and 120 kg, preferably 5 to 90 kg of sizing agent dry matter per tonne of paper.

In the present context, all the weight percentages are to be understood as weight percentages of the dry mass. This is because, as is known, in a paper and/or cardboard manufacturing process the solids content in the suspension present in each case changes several times in the course of the process due to, for example, drying or the like, so that the specification of absolute values is necessary.

In the present context, lignin is understood to mean any type of lignin, in particular a commercially available strongly acidic lignin, as well as an alkaline, i.e., black, lignin which was removed from the process before the acidic wash.

As corresponds to a further development of the present invention, the surface sizing agent is further developed in such a manner that red liquor with a content of 5 to 80% by weight of lignosulfonates is contained as the lignosulfonate source, with the result that a maximum effect can be achieved with a small amount of red liquor used as a lignosulfonate source contained in the surface sizing agent. By providing a surface sizing agent which uses a red liquor containing 5 to 80% by weight of lignosulfonate, by using the sizing agent it is possible to form an extremely homogeneous and highly air-permeable paper surface which, for example, is particularly well suited for a subsequent printing process. The lignosulfonate content of the red liquor, which is preferably used as a lignosulfonate source, can be adjusted by using it either directly as liquid red liquor originating from the NSSC process, which only has solids contents of less than about 10%, or as a lignosulfonate-containing product originating from spray drying of the red liquor which has again been dissolved or suspended. Particularly in the second case, the lignosulfonate content of the re-suspended red liquor can be adjusted as desired.

Such a surface sizing agent containing red liquor as a lignosulfonate source can be used particularly favourably since, on the one hand, it uses a waste product, namely the red liquor, as one of the starting materials, with the result that, compared to known manufacturing processes, the input materials that have to be supplied for separate processing can be significantly reduced and on the other hand, a surface sizing agent can be provided which, due to the significantly higher proportions of dissolved components, can penetrate better and more deeply into the paper surface of a paper to be coated therewith and/or a cardboard to be coated therewith. Furthermore, it has surprisingly been shown that by using red liquor in the sizing agent, the porosity or air permeability of the papers sized with the sizing agent could be improved significantly more than with conventional sizing agents, as could be confirmed in particular by measuring the air permeability of the paper (Gurley value according to ISO 5636-5:2013). This improved porosity is attributed to lignin particles finely distributed in the suspension and is particularly advantageous when using the sizing agent in the bag area, where a high air permeability is usually required.

Since the surface sizing agent has a pH in the range of 5 to 10, preferably 7.5 to 9.5, before it is applied, a weakly basic surface sizing agent is provided in which lignin is still soluble and which, due to the lignosulfonate source contained therein, for example the red liquor, is not so strongly basic that it could, for example, cause damage to the surface fibres of a paper and/or a cardboard. Particularly favourable and preferred properties can be achieved if the surface sizing agent has a pH in the range of 7 to 9.5, in which case it has been shown that the lignosulfonate source which is a component of the sizing agent is able to dissolve particularly large amounts of lignin, in particular kraft lignin, and at the same time the proportion of undissolved suspended matter in the surface sizing agent can be minimized, in particular before it is mixed with starch.

Although it is known that lignin and lignosulfonates can be used as surface-finishing agents, according to the invention the best properties on a paper and/or cardboard surface are achieved whereby, as corresponds to a further development of the invention, the surface sizing agent contains at least one further surface-finishing substance, in particular that the at least one further surface-finishing substance is contained in an amount of up to 97% by weight, preferably up to 85% by weight, even more preferably up to 80% by weight and most preferably up to 75% by weight of all soluble and/or suspendable components contained in the surface sizing agent. Surface-finishing substances such as tall oil, polymers such as polymers based on styrenes, acrylates or synthetic rubber, starch or other refined products such as hydrophobic agents such as succinic anhydride, alkyl ketene dimers, waxes or oils can give paper and/or cardboard coated therewith a wide variety of surface properties such as smoothness, gloss, a hydrophobic property, a hydrophilic property, a lipophilic property and the like and are therefore widely used, particularly for special applications and also applications in which the surface of the paper is to be printed. Such surface-finishing substances can usually be obtained relatively favourably and it has surprisingly been found according to the present invention that an admixture of small amounts of a mixture consisting of lignin and red liquor is already capable of suspending or replacing large amounts of such known and frequently used surface-finishing substances and that after application of such a suspension, paper and/or cardboard surfaces treated therewith have excellent properties. In particular, it has been shown that the surface sizing agent can penetrate deep into the paper and/or cardboard surface due to the low content of undissolved lignin particles therein and can thus form a homogeneous, easily printable and, in particular, hydrophobic surface. If amounts of the other surface-finishing substances of up to 97% by weight, preferably up to 85% by weight, even more preferably up to 80% by weight and most preferably up to 75% by weight of all the soluble and/or suspendable components contained in the surface sizing agent are present, this is usually a mixture of more than one surface-finishing substance, in particular a mixture containing starch.

Since, as corresponds to a further development of the present invention, the further surface-finishing substance contained in the surface sizing agent is starch, in particular gelled and enzymatically cooked native starch or swollen native starch, the penetration depth of such a surface sizing agent into a paper to be sized and/or a cardboard to be sized can be improved even further, with the result that the mechanical properties of the paper and/or cardboard treated in this way as well as their specific volume can be further increased. Due to the high proportion of dissolved lignin in the weakly basic red liquor containing lignosulfonates, the sizing efficiency can be improved with the surface sizing agent according to the invention, the polarity of the surface of the sized paper can be reduced and in particular the total amount of surface sizing agent applied can be reduced.

Since, as corresponds to a further development of the invention, the surface sizing agent is configured such that the at least one further surface-finishing substance is a mixture of up to 99% by weight of all soluble and/or suspendable components of starch contained in the surface sizing agent and up to 15% by weight of all soluble and/or suspendable components of natural or synthetic hydrophobic materials contained in the surface sizing agent, such as synthetic, hydrophobic materials such as synthetic or natural waxes, styrenes, butadiene, acrylates, alkyl ketene dimer and oils thereof, such as AnKD, alkylene succinic anhydride, it is possible to provide a particularly homogeneous surface sizing that penetrates deep into the paper surface and is particularly easy to print on. Furthermore, the air resistance of paper treated with the sizing agent could be significantly reduced. This reduction in air resistance is already noticeable with very small amounts of the lignosulfonate source used, such as red liquor, in the sizing agent and becomes even stronger in the direction of a weakly basic or neutral pH of the lignosulfonate source used. It is assumed that this completely unexpected effect is caused by the fact that the lignin particles are more easily dispersible in the lignosulfonate source, such as red liquor, than in conventional suspensions and that as a result of this better dispersion a significantly homogeneous surface-sized paper can be obtained.

The invention further relates to a process for producing a surface sizing agent for paper and/or cardboard containing lignin and lignosulfonates, which process is characterized in that a lignosulfonate source with a pH in the range of 5 to 10, preferably 7 to 9.5, at a temperature of 60 to 80° C. is mixed with lignin, in particular kraft lignin, whilst stirring, that after the formation of a solution which is substantially free of suspended matter, optionally after adding water, at least one further surface-finishing substance selected from the group of hydroxylated polymers, such as starch, PVOH, natural or synthetic, hydrophobic materials, such as tall oil, tall oil soap or refined products thereof in an amount of up to 93% by weight, preferably up to 85% by weight, even more preferably up to 80% by weight and most preferably up to 75% by weight of all dissolved and/or components contained in the surface sizing agent is added. By conducting the process in such a way that a lignosulfonate source with a pH in the range of 5 to 10, preferably 7 to 9.5, is mixed with lignin, in particular kraft lignin, at a temperature of 60 to 80° C. whilst stirring, it is possible to produce a lignin-containing solution which, compared to conventional solutions or suspensions of lignin, has a significantly reduced proportion of undissolved substances, so that a surface sizing agent produced using such a process can penetrate significantly more deeply into the surface of the paper and/or cardboard compared to conventional surface sizing agents and at the same time can provide significantly more homogeneous surface properties. By mixing at least one further surface-active substance into such a solution of the lignosulfonate source, such as red liquor, and lignin, a surface sizing agent is provided which is significantly more homogeneous than conventional surface sizing agents and enables an improved depth of penetration into the paper and/or cardboard to be treated therewith, with the result that not only the homogeneity of the paper thus treated and the cardboard thus treated is improved, but also the mechanical properties and in particular the printability of a paper and/or cardboard surface treated in this way can be significantly improved. At the same time, with such a process control, it is possible to reuse the waste product red liquor in paper and/or cardboard production instead of having to process it at great expense, and thus improve the overall energy balance of the process.

A surface sizing agent that can be penetrated particularly well into a paper surface is achieved according to the invention by continuing to stir the mixture of the lignosulfonate source and lignin and, if necessary, water for a duration of between 10 and 30 minutes until a solution free of suspended matter of not more than 1% by weight, preferably not more than 0.5% by weight, of undissolved solid particles is achieved. The preferred duration of 10 to 30 minutes results from the solubility of the lignin in the basic lignosulfonate source and surprisingly depends on the pH of the lignosulfonate source. The more basic the lignosulphonate source, for example red liquor, the stronger the dispersing/dissolving effect of the lignosulphonate source. This can be explained by the fact that, for example, the red liquor used as a lignosulfonate-source is a mixture of dissolved and sulfonated lignin, the lignosulfonate, which is water-soluble in a wide pH range of around 5 to 12, as well as dissolved sugars and natural hydrophobic substances of the red liquor that have a proportion of ionizable charge carriers which is why the dispersing/dissolving effect increases with increasing pH. Furthermore, the sizing agent also contains lignin, in particular kraft lignin, which is present as a solid at a pH of <10. As stated, red liquor or red liquor mixed with spray-dried lignosulfonate covers a wide, preferably alkaline basic pH range, a better dispersion/solution of kraft lignin is thus achieved with a strongly basic lignosulphonate source.

By carrying out the process in such a way that starch, in particular gelled and enzymatically cooked native starch or swollen native starch, is used as a further surface-finishing substance in an amount of up to 98% by weight, preferably up to 85% by weight, even more preferably up to 80% by weight and most preferably up to 75% by weight of all soluble and/or suspendable components contained in the surface sizing agent, it is possible to further strengthen the hydrophobic properties of the dissolved lignosulfonate in the lignosulfonate source and in particular ensure that on the surface of such a coated paper and/or such a coated cardboard no lignin particles remain as solid particles, so that an inhomogeneous surface of a paper thus coated as well as lignin particles remaining on the surface can be avoided. Above all, the fact that with the method according to the invention it is possible to achieve an almost complete penetration of the lignin particles into the interior of the paper provides significant-advantages in that a paper coated in this way does not create dust due to powdery lignin remaining on the surface. Finally, by using a surface sizing agent produced according to the process, it is possible to create homogeneous paper and/or cardboard surfaces into which the surface sizing agent has penetrated deeply with the result that a good air permeability of the paper is ensured. At the same time, it can be ensured that the amount of surface sizing agent used is not increased compared to conventional surface sizing processes, but can even be slightly reduced.

The present invention is further aimed at the use of the surface sizing agent according to the invention. Surprisingly, it has been shown that optimal results can be achieved with the surface sizing agent according to the invention when used on a dry paper surface with a film press and/or swamp size press, as well as it can be applied or introduced onto a moist paper web or between two layers of paper using a spray process, in which the droplet size can be adjusted. Such a use is advantageous, for example, in the production of multi-layer packaging papers. Another advantage of applying the sizing agent by spraying can be achieved by applying it in the area of the wire section together with starch or possibly also swollen but not yet cooked starch. Here, deep penetration of the suspension into the interior of the web to be dewatered is achieved primarily by reducing the viscosity of the suspension to be sprayed and the fine dispersion of the particles in the same.

### DESCRIPTION OF THE DRAWINGS

The present invention is explained in more detail below using exemplary embodiments and drawings. In these

FIG. 1 shows a diagram showing the amount of undissolved particles in specific lignin and red liquor solutions,

FIG. 2 shows a block diagram showing an industrial test on a paper machine in which the Cobb 60 values of a paper sized with a conventional surface sizing agent are compared with that of a paper sized with a surface sizing agent according to the invention,

FIG. 3 shows a comparison of SCT values of paper sized with conventional surface sizing agents and paper sized with a surface sizing agent according to the invention, and

FIG. 4 shows an industrial test on a paper machine comparing the TSI (tensile strength index according to ISO 1924-2) of papers sized with a) a conventional surface sizing agent, b) a sizing agent containing red liquor and lignin and c) a synthetic sizing agent.

### DETAILED DESCRIPTION OF THE INVENTION

### Example 1: Experiments Relating to the Dissolution of Lignin in Solutions Containing Lignosulfonate or in Red Liquor

In order to determine whether and to what extent improved solubility of lignin can be achieved through the use of red liquor, various samples were subjected to solubility tests. The samples examined were composed as follows:
1. 5% lignin, solution in water at pH 9.5 and 7
2. 10% lignin, solution in water at pH 9.5 and 7
3. 15% lignin, solution in water at pH 9.5 and 7
4. 15% lignin, solution in water and 5% by volume red liquor at pH 9.5 and 7
5. 15% lignin, solution in water and 10% by volume red liquor at pH 9.5 and 7
6. 15% lignin, solution in water and 15% by volume red liquor at pH 9.5 and 7

The mixing was carried out at a temperature of 65*C±3° C. for 30 min, wherein firstly lignin and water were mixed, the dry content was determined and then the solution was adjusted to a pH of 9 with a 1N sodium hydroxide/hydrochloric acid mixture. After the end of mixing, the amount of undissolved particles was determined by gravimetry by weighing a pre-weighed fine cellulose filter (quantitative filter paper 474 VWR) over a Büchner funnel. When using red liquor, the procedure was similar but 5%, 10% to 15% of the water was replaced with red liquor.

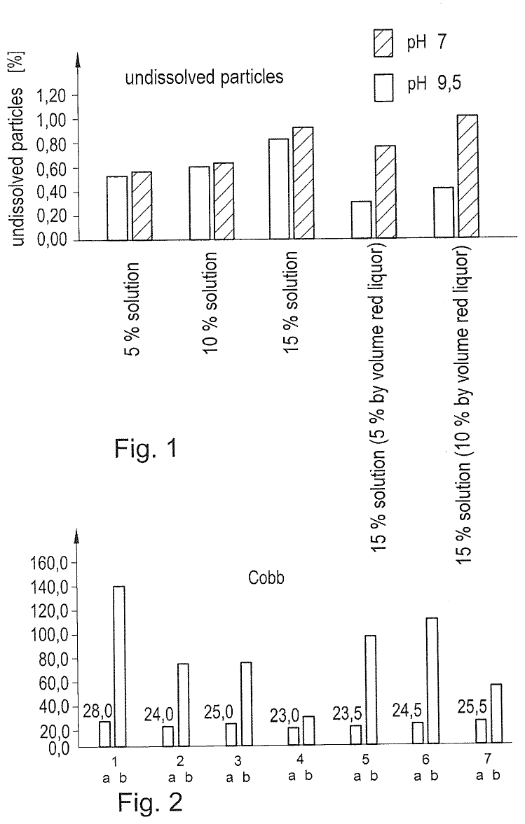

From FIG. 1 it can be seen that the solids content of solutions formed at pH 7 and pH 9.5 barely differs in relation to the amount of solid particles contained therein. If, as described according to the invention, part of the water is replaced by red liquor, it becomes apparent, especially at pH 9.5, that red liquor can surprisingly be used as a solubilizer for lignin in the production of surface sizing agents.

### Example 2: Comparison of the Use of Different Sizing Agents on a Kraft Paper

In the following Table 1, compositions, application quantities, viscosities at different temperatures as well as a pH of the same of a number of sizing agents, sizing agents A to I, which consist of both red liquor and lignin from black liquor or only either a conventional sizing agent, namely starch and finally also a combination of starch and lignin from black liquor (lignin unwashed), are compiled. Table 2 summarizes the paper properties obtained when the various sizing agents A to I are used on a base paper, in the present case a kraft paper with a basis weight of 150 g/m².

Among the tests carried out were three comparative tests, namely test 1, in which only starch was used as the surface sizing agent, and tests 2 and 6, in each of which a surface sizing agent containing 50 parts by weight of starch and 50 parts by weight of lignin from black liquor was used, but at different pH, namely 7 and 9.5. Of the sizing tests carried out with surface sizing agents according to the invention, three were carried out at a pH of 7 and three at a pH of 9.5.

TABLE 1
Sizing agents

| Parameter | Unit | Test 1 | Test 2 | Test 3 | Test 4 | Test 5 | Test 6 | Test 7 | Test 8 | Test 9 |
|---|---|---|---|---|---|---|---|---|---|---|
| Formulation | | A | B | C | D | E | F | G | H | I |
| Dry matter | % | 15 | 15 | 15 | 15 | 15 | 15 | 15 | 15 | 15 |
| content | | | | | | | | | | |
| (target) | | | | | | | | | | |
| Dry matter | % | 14.32 | 14.73 | 14.68 | 14.16 | 14.61 | 14.73 | 14.68 | 14.16 | 14.61 |
| content | | | | | | | | | | |
| (actual) | | | | | | | | | | |
| Application | g/m³ | 3 | 3 | 3 | 3 | 3 | 3 | 3 | 3 | 3 |
| quantity | | | | | | | | | | |
| (target) | | | | | | | | | | |
| Application | g/m² | 2.76 | 2.86 | 2.96 | 2.89 | 2.89 | 2.84 | 2.97 | 2.86 | 2.91 |
| quantity | | | | | | | | | | |
| (actual) | | | | | | | | | | |
| Basis weight | g/m² | 150 | 150 | 150 | 150 | 150 | 150 | 150 | 150 | 150 |
| pH | pH | Strength | 7 | 7 | 7 | 7 | 9.5 | 9.5 | 9.5 | 9.5 |
| | | (6.5) | | | | | | | | |
| 1st | | 100T | 50T | 50T | 50T | 50T | 50T | 50T | 50T | 50T |
| component | | strength | strength | strength | strength | strength | strength | strength | strength | strength |
| 2nd | | | 50% lignin | 47.5% lignin | 45% lignin | 25% lignin | 50% lignin | 47.5% lignin | 45% lignin | 25% lignin |
| component | | | (unwashed) | (unwashed) | (unwashed) | (unwashed) | (unwashed) | (unwashed) | (unwashed) | (unwashed) |
| 3rd | | | | 2.5T red | 5T red | 25T red | | 2.5T red | 5T red | 25T red |
| component | | | | liquor | liquor | liquor | | liquor | liquor | liquor |

Viscosity at 20° C.

| | | | | | | | | | | |
|---|---|---|---|---|---|---|---|---|---|---|
| 60 rpm | mPas | 157.8 | 40.3 | 38.6 | 43.6 | 44.3 | 40.3 | 38.6 | 43.6 | 44.3 |
| 120 rpm | mPas | 160.1 | 44.7 | 44.0 | 48.0 | 50.7 | 44.7 | 44.0 | 48.0 | 50.7 |
| 240 rpm | mPas | 165.9 | 58.8 | 56.0 | 54.0 | 60.8 | 58.8 | 56.0 | 54.0 | 60.8 |
| 360 rpm | mPas | 174.2 | 65.5 | 64.9 | 59.9 | 69.5 | 65.5 | 64.9 | 59.9 | 69.5 |
| 3480 rpm | mPas | 183.6 | 73.7 | 73.7 | 75.2 | 76.7 | 73.7 | 73.7 | 75.2 | 76.7 |

Viscosity at 65° C.

| | | | | | | | | | | |
|---|---|---|---|---|---|---|---|---|---|---|
| 60 rpm | mPas | 46.9 | 14.7 | 14.0 | 17.0 | 17.1 | 14.7 | 14.0 | 17.0 | 17.1 |
| 120 rpm | mPas | 50.2 | 19.5 | 19.0 | 20.0 | 21.5 | 19.5 | 19.0 | 20.0 | 21.5 |
| 240 rpm | mPas | 60.5 | 27.9 | 26.5 | 25.5 | 29.1 | 27.9 | 26.5 | 25.5 | 29.1 |
| 360 rpm | mPas | 69.2 | 30.9 | 31.5 | 30.5 | 34.2 | 30.9 | 31.5 | 30.5 | 34.2 |
| 480 rpm | mPas | 77.3 | 37.3 | 34.3 | 35.0 | 39.2 | 37.3 | 34.3 | 35.0 | 39.2 |
| Total amount | [kg/ton] | 16.2 | 9.1 | — | — | 9 | 8.7 | — | — | 9.1 |
| of starch | | | | | | | | | | |
| applied | | | | | | | | | | |
| Total amount | [g/m²] | 2.4 | 1.4 | — | — | 1.3 | 1.3 | — | — | 1.4 |
| of starch | | | | | | | | | | |
| applied | | | | | | | | | | |
| Amount of | [g/m²] | 2 | 1 | — | — | 1 | 1 | — | — | 1 |
| starch on top | | | | | | | | | | |
| Amount of | [g/m²] | 0.4 | 0.4 | — | — | 0.4 | 0.3 | — | — | 0.4 |
| starch on | | | | | | | | | | |
| bottom | | | | | | | | | | |

The viscosity was measured at pH 7.
The lignin used in the experiment was black lignin

TABLE 2
Paper properties of kraft papers sized with sizing agents A to I

| Parameter | Unit | Test 1 | Test 2 | Test 3 | Test 4 | Test 5 | Test 6 | Test 7 | Test 8 | Test 9 |
|---|---|---|---|---|---|---|---|---|---|---|
| Breaking strength | N | 211.1 | \hat{ }209.5 | 200.8 | 200.8 | 202.4 | 210.3 | 198.2 | 194.1 | 203.5 |
| MD ISO1924-2 | | | | | | | | | | |
| Breaking strength | N | 87.4 | 89.0 | 92.3 | 88.2 | 93.8 | 97.0 | 93.6 | 96.2 | 93.6 |
| CD ISO1924-2 | | | | | | | | | | |
| Breaking strength. | N | 135.8 | 136.5 | 136.1 | 133.1 | 137.8 | 142.8 | 136.2 | 136.6 | 138.0 |
| geometric¹, calculated | | | | | | | | | | |
| Tear length MD | km | 9.57 | 9.50 | 9.10 | 9.10 | 9.17 | 9.53 | 8.98 | 8.80 | 9.22 |
| ISO1924-2 | | | | | | | | | | |
| Tear length CD | km | 3.96 | 4.04 | 4.18 | 4.00 | 4.25 | 4.40 | 4.24 | 4.36 | 4.24 |
| ISO1924-2 | | | | | | | | | | |
| Tear length geometric, | km | 6.16 | 6.20 | 6.17 | 6.03 | 6.24 | 6.48 | 6.17 | 6.19 | 6.25 |
| ISO 1924-2 | | | | | | | | | | |
| Tensile strength | kN/m | 14.08 | 13.97 | 13.39 | 13.39 | 13.50 | 14.02 | 13.21 | 12.94 | 13.57 |
| MD ISO 1924-2 | | | | | | | | | | |
| Tensile strength | kN/m | 5.83 | 5.94 | 6.16 | 5.88 | 6.25 | 6.47 | 6.24 | 6.41 | 6.24 |
| CD ISO 1924-2 | | | | | | | | | | |
| Tensile strength | kN/m | 9.06 | 9.11 | 9.08 | 8.87 | 9.19 | 9.52 | 9.08 | 9.11 | 9.20 |
| geometric ISO 1924-2 | | | | | | | | | | |
| Tensile strength | Nm/g | 59.31 | 59.59 | 59.37 | 58.04 | 60.08 | 62.31 | 59.35 | 59.58 | 60.18 |
| geometric ISO 1924-2 | | | | | | | | | | |
| Bursting strength | kPa | 607 | \hat{ }609 | 630 | 625 | 628 | 612 | 624 | 621 | 623 |
| TS ISO2758-1 | | | | | | | | | | |
| Bursting strength | kPa | 519 | 530 | 542 | 554 | 563 | 538 | 547 | 556 | 584 |
| BS ISO2758-1 | | | | | | | | | | |
| Mean bursting | kPa | 563 | 569.5 | 586 | 589.5 | 595.5 | 575 | 585.5 | 588.5 | 603.5 |
| strength ISO2758-1 | | | | | | | | | | |
| Gurley ISO 5636-1 | sec. | 179 | 162 | 150 | 135 | 122 | 188 | 173 | 158 | 134 |
| L* TS² | | 57.48 | 55.33 | 54.72 | 55.34 | 57.66 | 54.92 | 54.48 | 54.91 | 56.78 |
| L* BS ³ | | 64.3 | 64.32 | 64.13 | 63.91 | 63.84 | 64.46 | 64.02 | 63.77 | 63.54 |
| a* TS | | 9.07 | 9.47 | 9.55 | 9.58 | 8.98 | 9.4 | 9.49 | 9.38 | 8.94 |
| a* BS | | 6.99 | 7.02 | 7.12 | 7.26 | 7.22 | 6.96 | 7.08 | 7.06 | 7.08 |
| b* TS | | 22.55 | 22.86 | 22.91 | 23.07 | 23.75 | 22.63 | 22.89 | 23.06 | 23.83 |
| b* BS | | 18.21 | 18.39 | 18.58 | 18.97 | 18.98 | 18.28 | 18.44 | 18.56 | 18.84 |
| Friction coefficient | | 0.32 | 0.33 | 0.33 | 0.37 | 0.38 | 0.34 | 0.35 | 0.36 | 0.38 |
| Glide angle | ° | 17.5 | 18.4 | 18.5 | 20.2 | 20.7 | 18.8 | 19.4 | 19.9 | 21 |

¹geometric means geometric mean/square root of the mathematical product of the value in the machine direction and the value in the cross direction
²TS means top side (top of the paper)
³ BS means bottom side (bottom of the paper
L*, a* and b* correspond to a colour space according to ISO11664-4 (https://de.wikipedia.org/wiki/Lab-Farbraum

### Example 3: Application of Sizing Agents on an Industrial Paper Machine

A two-ply product is produced on an industrial paper machine with a first layer (bottom side) consisting of 100% recycled fibres and the second layer (top side) consisting of 100% fresh fibres with a kappa number of 85 according to ISO 302, to which paper a surface sizing agent with a solids content of around 5% is applied using a swamp size press in an amount of 20 kg ATRO per tonne of paper. The surface sizing agent was applied in such a way that 25% by weight of red liquor, 5% by weight of kraft lignin and 70% by weight of enzymatically degraded starch were used on the bottom side (as shown by the bars on the right side in FIG. 2 to 4). When the paper is used to produce corrugated cardboard, the top side forms the liner, i.e. the side to be printed on, and thus the surface sizing agent was further refined by the addition of 7% by weight of a synthetic hydrophobic material from the class of an anionic styrene-acrylate (thus slightly reducing the % by weight of the red liquor or the lignin or the starch).

When testing a corrugated board comprising the above papers as top and base liner, it was surprisingly shown that the surface sizing agent for the bottom, even without the inclusion of a synthetic hydrophobic material, already exhibits a strong hydrophobic effect simply by the industrial operation using a size press, temperature control and drying, and that the Cobb 60 value according to ISO 535 could be further reduced by adding another synthetic hydrophobic material.

The industrial test on a paper machine shown in FIG. 2 shows the comparison of a conventional surface sizing agent with red liquor, lignin, starch and a hydrophobic material (reel number 30278041 No. 7 in FIGS. 2 to 4), as well as the comparison with other reels (Nos. 1 to 6 in FIGS. 2 to 4) on which paper is rolled, which do not contain red liquor and lignin. The reel numbers of the industrial test were as follows: 30278035=1 in the Figures, 30278036=2 in the Figures, 302878037=3 in the Figures, 30278038=4 in the Figures, 30278039=5 in the Figures and 30278040=6 in the Figure. Furthermore, a means top side and b means bottom side in the Figures.

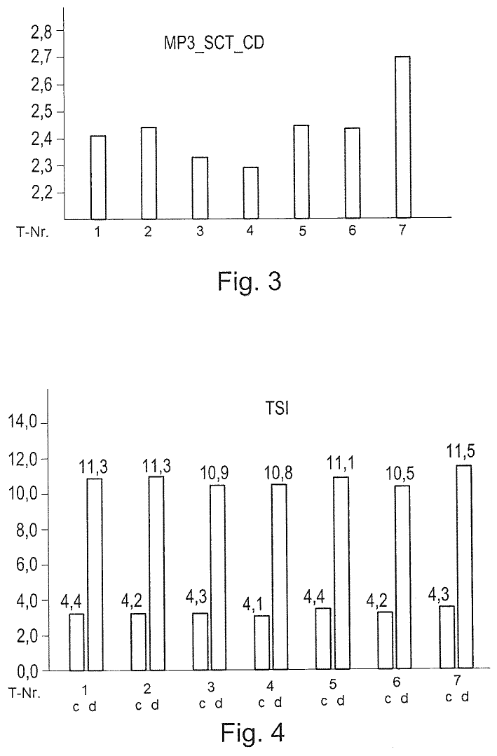

Furthermore, as can be seen from FIG. 3, it was surprisingly shown that the SCT value according to ISO 9895 (indicated in kN/m) can be significantly increased by industrial operation of the formulations with red liquor and kraft lignin. This can be indirectly attributed to the improved penetration of the surface sizing agent into the paper. Furthermore, it can be ruled out that this value was achieved by a changed fibre orientation in the paper, which results from the same tensile stiffness (TSI) in the transverse and longitudinal directions in the paper.

In FIG. 2 to 4, all the comparative tests and comparative values are shown on the last side, and the sizing agents according to the invention with red liquor and lignin as well as a synthetic sizing agent are shown on the right side in the Figure. The reel numbers of the individual tests carried out are shown on the abscissa in FIG. 2 to 4. Around 15 t of produced paper are wound onto each reel.

Finally, FIG. 4 shows an industrial test on a paper machine where a conventional surface sizing agent without red liquor and lignin was compared with a sizing agent with red liquor and lignin and a synthetic sizing agent in terms of the tensile strength index (TSI) to be obtained. C means CD and d means MD in the Figures.

These comparisons show that the Cobb 60 value of papers sized with a surface sizing agent according to the invention could be significantly reduced, but the strength properties of the paper were not adversely affected. Rather, the SCT value in the transverse direction (CD) in particular was significantly improved and the tensile strength index (TSI) was also further increased compared to conventionally sized papers.

1. A surface sizing agent for paper and/or cardboard containing lignin and lignin sulfonates and at least one further surface-finishing substance, containing 0.1 to 50% by weight of a lignosulfonate source, 0.1 to 50% by weight, of lignin and at least one further surface-finishing substance selected from the group consisting of hydroxylated polymers natural or synthetic hydrophobic materials, AnKD, alkenyl succinic anhydride and the remainder water as a solvent and/or suspending agent.

2. The surface sizing agent according to claim 1, wherein red liquor with a content of 5 to 50% by weight of lignosulfonates is contained as the lignosulfonate source.

3. The surface sizing agent according to claim 1, wherein it has a pH in the range from 5 to 10.

4. The surface sizing agent according to claim 1, wherein the at least one further surface-finishing substance is contained in an amount of up to 98% by weight of all soluble and/or dispersible components contained in the surface sizing agent.

5. The surface sizing agent according to claim 1, wherein the at least one further surface-finishing substance consists of a mixture of up to 99% by weight of all soluble and/or suspendable starch components contained in the surface sizing agent and up to 15% by weight of all soluble and/or suspendable components of natural or synthetic hydrophobic materials contained in the surface sizing agent, selected from polymers based on styrenes, acrylates or synthetic rubber, starch or succinic anhydride, alkyl ketene dimers, waxes or oils.

6. The surface sizing agent according to claim 1, wherein gelled and enzymatically cooked native starch or swollen native starch, is contained as a further surface-finishing substance.

7. A process for producing a surface sizing agent for paper and/or cardboard containing lignin and lignosulfates and at least one further surface-finishing substance, wherein a lignosulfonate source with a pH in the range of 5 to 10, and a temperature of 60 to 80° C. is mixed with lignin, whilst stirring, after forming a solution substantially free from non-dispersible particles and after adding water, the at least one further surface-finishing substance selected from the group consisting of hydroxylated polymers, or natural or synthetic materials, is added in an amount of up to 98% by weight, of all components dissolved and/or suspendable in the surface sizing agent to form a mixture.

8. The process according to claim 7, wherein stirring of the mixture the lignosulfonate source and lignin and water is carried out for a period of between 10 and 30 minutes until a solids content in a substantially clear solution of not more than 0.5% by weight is reached.

9. The process according to claim 7, wherein red liquor with a content of 5 to 50% by weight of lignosulfonates is used as the lignosulfonate source.

10. The process according to claim 7, wherein gelled and enzymatically cooked native starch or swollen native starch in an amount of up to 93% by weight of all soluble and/or suspendable components contained in the surface sizing agent is used as the further surface-finishing substance.

11. Use of the surface sizing agent according to claim 1 on a dried paper web, by applying the surface sizing agent to a dry paper web using a film press or a swamp size press.

12. Use of the surface sizing agent according to claim 1 on a moist paper web, on a surface with a paper layer or between two paper layers.
